(19) United States
(12) Patent Application Publication
(10) Pub. No.: US 2020/0408005 A1
(43) Pub. Date: Dec. 31, 2020

(54) BIDIRECTIONAL INERTIA LATCH FOR VEHICLE INTERIOR COMPONENTS

(71) Applicant: Ford Global Technologies, LLC, Dearborn, MI (US)

(72) Inventors: Diego Santillan gutierrez, Tizayuca (MX); Ignacio Adan Bautista, Nicolas Romero (MX); Daniel Cervantes, Puebla (MX); Raul Javier Elias, Ciudad de Mexico (MX)

(73) Assignee: Ford Global Technologies, LLC, Dearborn, MI (US)

(21) Appl. No.: 16/454,337

(22) Filed: Jun. 27, 2019

(51) Int. Cl. E05B 77/06; E05B 83/32; B60R 7/04

(52) U.S. Cl. CPC E05B 77/06; B60R 7/04; E05B 83/32

(57) ABSTRACT

A vehicle includes a latch mechanism configured to retain a movable interior component when the latch mechanism is latched. A movable latch release is operably connected to the latch mechanism. A bidirectional inertia lock includes an actuator member that unlatches the latch mechanism, and an inertia lock member that moves from an unlocked position to a locked position in response to vehicle acceleration in a fore-aft direction and a side-to-side direction. The inertia lock member prevents movement of the actuator member to the actuated position when the inertia lock member is in the locked position.

### FIELD OF THE INVENTION

The present invention generally relates to vehicle interior components, and in particular to a bidirectional latch that prevents unlatching of an interior component if predefined conditions are met.

### BACKGROUND OF THE INVENTION

Motor vehicles may include interior storage compartments and the like that may be selectively closed off by a movable component such as a door.

### SUMMARY OF THE INVENTION

One aspect of the present disclosure is a motor vehicle having a movable interior component. The vehicle has a fore-aft (first) direction that may be horizontal, and a second direction that is substantially transverse to the first direction. The second direction may be horizontal or approximately horizontal. The vehicle may include an interior compartment having a storage space with an upper opening. A movable component such as a door is configured to selectively close off the upper opening. A latch mechanism is configured to retain the door in a closed position when the latch mechanism is latched. The latch mechanism permits the door to open when the latch mechanism is in an unlatched position or configuration. A movable latch release is operably connected to the latch mechanism. A bidirectional inertia lock has an unlocked configuration in which the movable latch release can be moved to unlatch the latch mechanism. The bidirectional inertia lock also has a locked configuration in which the latch mechanism cannot be unlatched to move the door. The bidirectional inertia lock includes a support structure that may be connected to the interior compartment, and an actuator member that is movable from a rest position to an actuated position. Movement of the actuator member from the rest position to the actuated position unlatches the latch mechanism. The bidirectional inertia lock further includes an inertia lock member that is configured to rotate about a vertical axis from an unlocked position to a locked position. The inertia lock member permits movement of the actuator member to the actuated position when the inertia lock member is in the unlocked position, and the inertia lock member prevents movement of the actuator member to the actuated position when the inertia lock member is in the locked position. The inertia lock member has a center mass that is offset from the vertical axis such that the inertia lock member rotates to the locked position in response to acceleration in the first direction, and also rotates to the locked position in response to acceleration in the second direction.

Embodiments of the first aspect of the invention can include any one or a combination of the following features:
The interior storage compartment may optionally include first linear guides;
The door may optionally slidably engage the first linear guides to permit linear fore-aft movement of the door relative to the interior storage compartment when the latch mechanism is released.
The latch mechanism may optionally include a base member fixed to the base structure.
The latch mechanism may optionally include a locking member that selectively engages the base member when the inertia lock member is latched to prevent movement of the door.
The base member may optionally comprise an elongated base structure extending a fore-aft direction and including a plurality of recesses.
The locking member may optionally include at least one protrusion that engages at least a selected one of the recesses when the inertia lock member is latched to prevent fore-aft movement of the door.
Movement of the latch release from the rest position to the released position may disengage the protrusion from the at least one recess to permit fore-aft movement of the door.
The latch release and the locking member may be movably interconnected by at least one cam member and cam surface whereby movement of the latch release in the first direction causes the locking member to shift in a direction that is transverse to the first direction.
The locking member may include a plurality of elongated slots that extend at an acute angle relative to the first direction.
The latch release may comprise an actuator bracket having protrusions that are received in the elongated slots.
The vehicle interior compartment may include at least one spring biasing the actuator bracket to the rest position whereby the at least one spring causes the actuator bracket to shift to the rest position after a user releases the latch release to thereby shift the at least one protrusion of the locking member into engagement with a recess of a base member.
The inertia lock member may include a lock surface that engages the latch release and prevents movement of the latch release to the released position when the inertia lock member is in the locked position.
The vehicle interior compartment may optionally include a spring biasing the inertia lock member to the unlocked position.
The latch release may optionally include an opening.
The lock surface of the inertia lock member may optionally comprise a protrusion that is received in the opening.
The opening in the latch release may optionally include an edge portion forming a stop that engages the protrusion and prevents movement of the latch release to the released position when the inertia lock member is in the locked position.
The opening in the latch release may optionally include a portion that receives the protrusion and permits movement of the latch release to the released position when the inertia lock member is in the unlocked position.

Another aspect of the present disclosure is a vehicle having a fore-aft first direction and a side-to-side second direction that is transverse to the first direction. The vehicle may include a base structure and an interior component that is movably mounted to the base structure for horizontal fore-aft movement between first and second positions. The vehicle may include a latch mechanism having latched and unlatched configurations. The latch mechanism may prevent fore-aft movement of the interior component when the latch mechanism is in the latched configuration, and may permit fore-aft movement of the interior component when the latch mechanism is in the latched configuration. The vehicle may include a manually movable latch release that is operably connected to the latch mechanism whereby manual movement of the latch release from a rest position to a released position unlatches the latch mechanism. The vehicle may include an inertia lock member that is rotatable about a vertical axis. The inertia lock member may have a center of mass that is offset from the vertical axis such that the inertia lock member rotates from an unlocked position to a locked position in response to acceleration in the first direction, and in response to acceleration in the second direction. The inertia lock member may prevent movement of the latch release to the released position when the inertia lock member is in the locked position.

Embodiments of the second aspect of the invention can include any one or a combination of the following features:
The inertia lock member may optionally rotate from an unlocked position to a locked position in response to acceleration in the first direction only if acceleration in the first direction is equal to or greater than about 30 g.
The inertia lock member may optionally rotate from an unlocked position to a locked position in response to acceleration in the second direction only if the acceleration in the second direction is equal to or greater than about 10 g.
The vehicle may include a body structure, and the latch mechanism may include a reinforcement bracket fixed to the body structure.
The reinforcement bracket may optionally include a plurality of recesses.
The inertia lock member may optionally include a locking member that moves fore-aft with the interior component and selectively engages at least one of the recesses of the reinforcement bracket to retain the interior component at a selected fore-aft position.
The latch release may, optionally, be movably mounted to the interior component for fore-aft movement relative to the interior component between the rest and released positions.
The latch release and the locking member may be operably interconnected by cam surfaces such that fore-aft movement of the latch release shifts the locking member in a direction that is transverse to the fore-aft direction.
The inertia lock member optionally engages a stop surface of the latch release when the inertia lock member is in the locked position to prevent movement of the latch release to the released position.
The base structure optionally comprises a storage compartment having an upwardly-facing opening.
The interior component optionally comprises a door that closes off the upwardly-facing opening when the door is in the first position, and permits access to the upwardly-facing opening when the door is in the second position.
The first direction may comprise a vehicle forward direction, and the door may move in the vehicle forward direction from the first position to the second position.

Another aspect of the present disclosure is a method of preventing movement of a vehicle interior component of a vehicle when the vehicle experiences acceleration in a forward direction exceeding a predefined first acceleration, and when the vehicle experiences acceleration in a side-to-side direction exceeding a predefined second acceleration. The method may include providing an inertia lock member that is rotatably connected to a vehicle component for rotation about a vertical axis. An interior component may be movably connected to the vehicle in an interior of the vehicle. The inertia lock member may be configured to rotate from an unlocked position to a locked position to prevent movement of the interior component when the vehicle experiences acceleration in a forward direction exceeding a predefined first acceleration and when the vehicle experiences acceleration in a side-to-side direction exceeding a predefined second acceleration.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a partially schematic isometric view of a vehicle interior;

FIG. 2 is a partially fragmentary isometric view of a portion of an interior of the vehicle of FIG. 1;

FIG. 2A is a partially schematic isometric view of the vehicle interior of FIG. 2 showing a movable interior component in a forward position;

FIG. 3 is an isometric exploded view of an interior storage compartment of the vehicle of FIGS. 1 and 2;

FIG. 4 is an exploded isometric view of a bracket and release assembly;

FIG. 5 is a top plan view of a bracket and release assembly showing the inertia lock member in an unlocked position;

FIG. 6 is a plan view of the bracket assembly of FIG. 5 showing the inertia lock member in an unlocked position;

FIG. 7 is a fragmentary enlarged view of a portion of the bracket assembly of FIG. 5;

FIG. 8 is a fragmentary enlarged view showing the inertia lock member in an unlocked position; and

FIG. 9 is partially fragmentary isometric view of an inertia lock member.

### DETAILED DESCRIPTION OF THE PREFERRED EMBODIMENTS

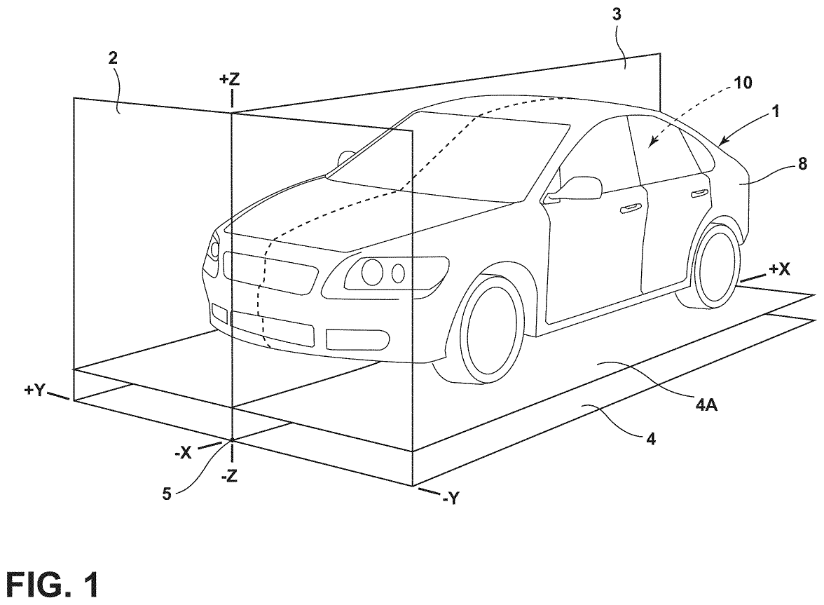

For purposes of description herein, the terms “upper,” “lower,” “right,” “left,” “rear,” “front,” “vertical,” “horizontal,” and derivatives thereof shall relate to the disclosure as oriented in FIG. 1. However, it is to be understood that the disclosure may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

With reference to FIG. 1, a vehicle 1 defines a coordinate system including a vertical transverse (side-to-side) X plane 2, a vertical longitudinal (fore-aft) Y plane 3, and a horizontal (zero grid) Z plane 4. The X, Y, and Z planes 2-4 intersect at an origin 5. Vehicle 1 may be disposed on ground 4A.

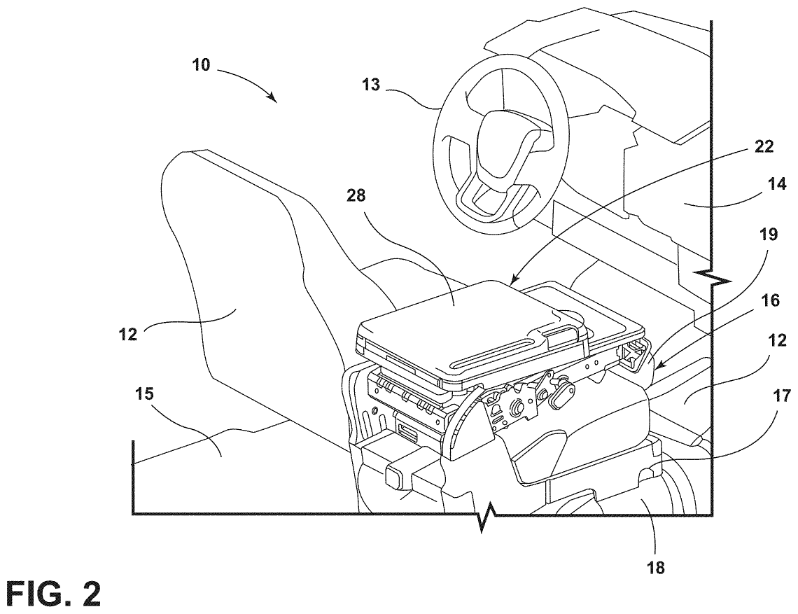

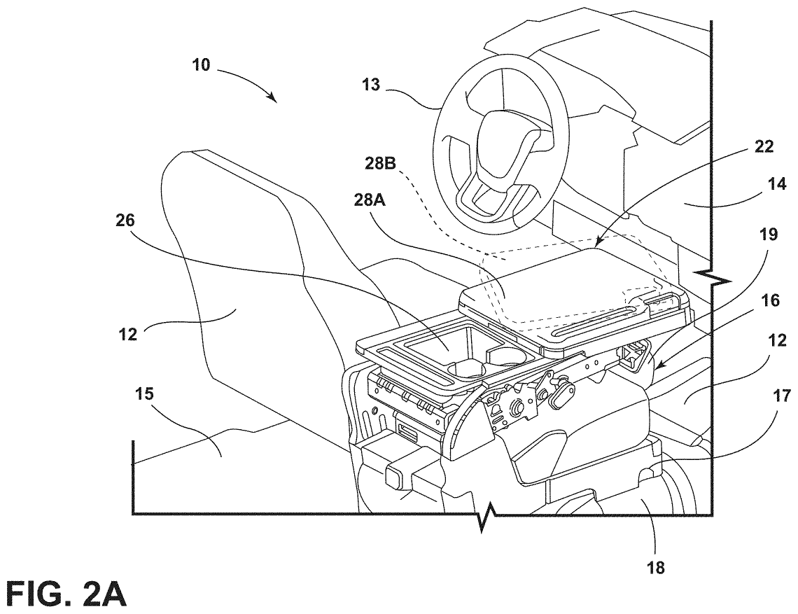

Vehicle 1 includes a body 8 and an interior space 10. With reference to FIGS. 2 and 2A, the interior space 10 of vehicle 1 may include one or more seats 12, steering wheel 13, dashboard 14, and a floor 15. The vehicle 1 may further include a center console assembly 6, including a center seat 16 having a base 17 that is mounted to a console 18 of floor 15 between the seats 12, and a back 19 that may be folded downwardly to provide a workstation upper surface 20. It will be understood that forward-folding center seats for vehicles such as pickup trucks are generally known.

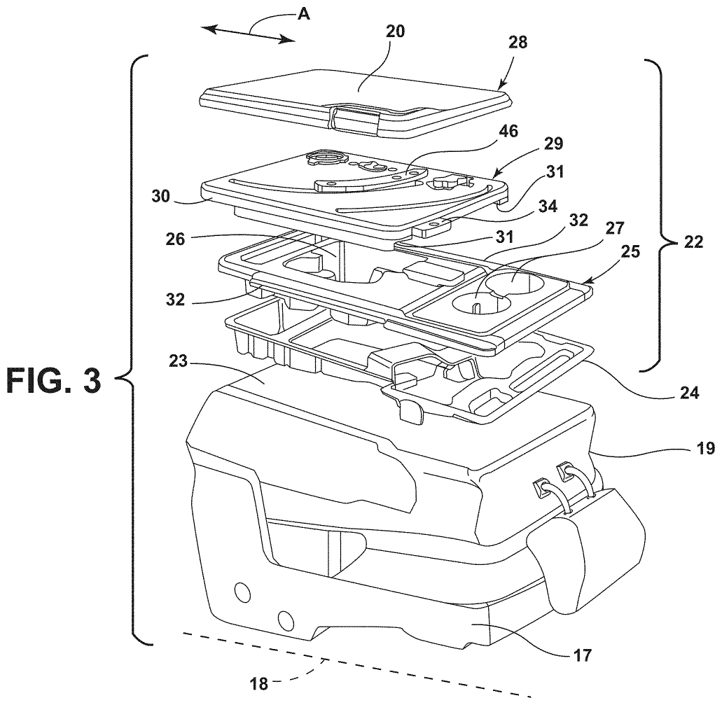

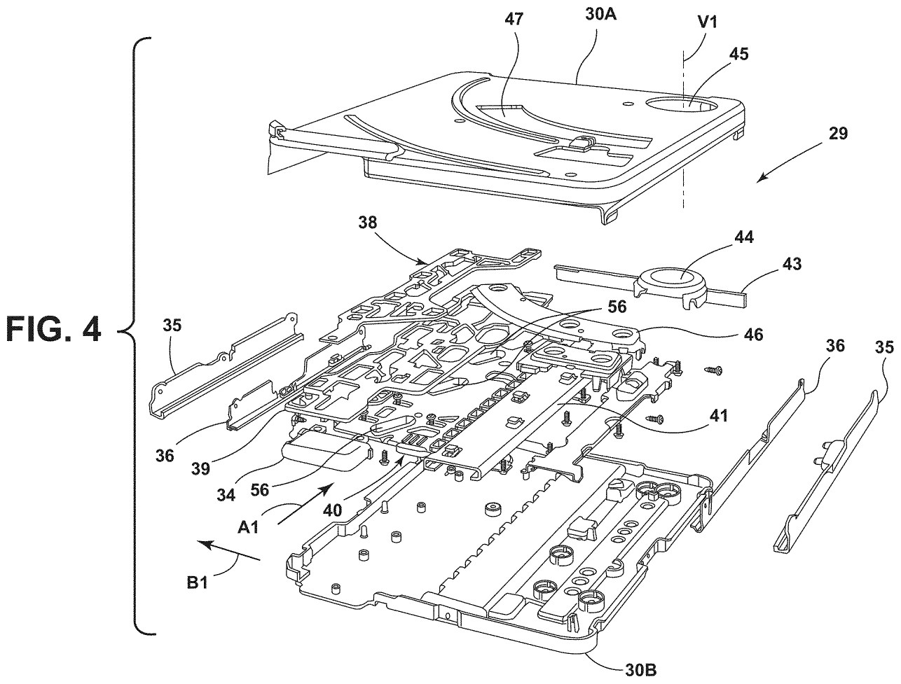

With further reference to FIG. 3, a storage compartment assembly 22 may be positioned on surface 23 of seat back 19. When the seat back 19 is in the stowed position of FIG. 3, the back surface 23 faces upwardly. The storage compartment 22 includes a base structure such as bracket 24 that may be secured to the seat back 19, and a bin 25 having one or more storage receptacles or spaces 26 and 27. The bin 25 may be secured to the base bracket 24. It will be understood that the size and shape of the bin 25 may vary. For example, the base bracket 24 may be configured to mount directly to console 18 or other floor structure, and the bin 25 may include relatively large storage compartments or spaces 26, 27, etc. in place of center seat 16. A movable interior component 28 may comprise a work surface or door. Movable interior component may be movably interconnected to the bin 25 by a slide or adjustment assembly 29 for movement from a “home” position (FIG. 2) to a forward position “28A” (FIG. 2A). The slide or adjustment assembly 29 may include a housing 30 forming inwardly-facing grooves 31 that slidably engage linear guides 32 of bin 25 to permit fore-aft (±X) direction sliding movement of adjustment assembly 29 and top 28 relative to the bin 25. The movable interior component 28 may be secured to the slide assembly 29 such that movable interior component 28 and slide assembly 29 move together relative to the bin 25. As discussed in more detail below, a release button 34 can be pushed inwardly (rearwardly in a +X direction in vehicle coordinates) by a user to release the slide assembly 29 to permit movement of top 28 in the fore-aft (±X) direction relative to bin 25. Movable interior component may also pivot about vertical axis V1 (FIG. 4) towards the driver's side to a position 28B (FIG. 2A) to support laptop or tablet computers, paper documents, or other items.

The storage spaces 26, 27, etc. are optional, and the movable interior component 28 may be configured for use solely as a work surface (i.e. not to close off a storage space). Conversely, the movable interior component 28 may be configured solely to open and close spaces 26, 27, etc., whereby the movable interior component 28 is not configured to be used as a work surface. Also, it will be understood that the inertia latch of the present disclosure could be utilized in connection with virtually any type of movable member in virtually any type of vehicle.

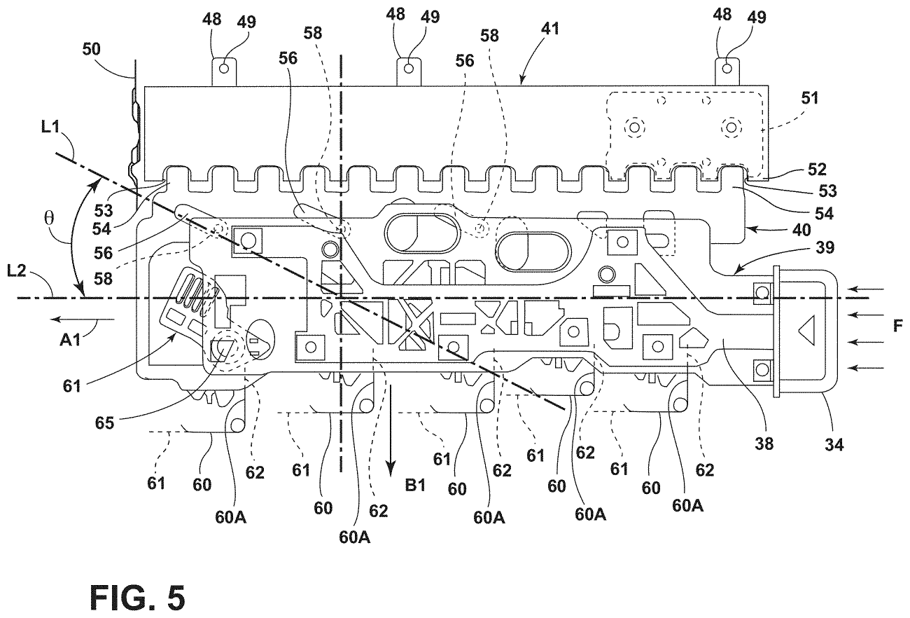

With reference to FIG. 4, the slide assembly 29 includes upper and lower housing members 30A and 30B and slide brackets 35 and 36 that form inwardly facing grooves 31 to slidably interconnect slide assembly 29 to bin 25. When assembled, an upper bracket 38 is secured to a latch release such as actuator bracket 39, and push button 34 is secured to the brackets 38 and 39 (see also FIGS. 5-8). As discussed in more detail below, the actuator bracket 39 is operably interconnected with a locking member such as locking bracket 40 such that movement of actuator bracket 39 in a fore-aft direction of arrow “A1” causes transverse movement of locking bracket 40 as shown by the arrow “B1.” The transverse movement of locking bracket 40 in the direction of arrow B1 and the direction opposite arrow B1 causes the locking bracket 42 to disengage and engage, respectively, from a fixed base member such as reinforcing bracket 41. More specifically, movement of button 34 and actuator bracket 39 in the direction of the arrow A1 causes locking bracket 40 to move in the direction of the arrow B1, thereby disengaging locking bracket 40 from reinforcement bracket 41, thereby permitting fore-aft movement of slide assembly 29 and top 28 in the direction of the arrow A (FIG. 3). Conversely, when button 34 moves in a direction opposite arrow A1, bracket 40 moves in a direction opposite arrow B1.

Slide assembly 29 may also include a pivot bracket 43 having a disc portion 44 that is received in a circular opening 45 of upper housing member 30A. An arcuate bearing member 46 may extend through an arcuate opening 47 in upper housing member 30A to slidably support top 28 for rotation about a vertical axis “V1” to a rotated position 28B (FIG. 2A).

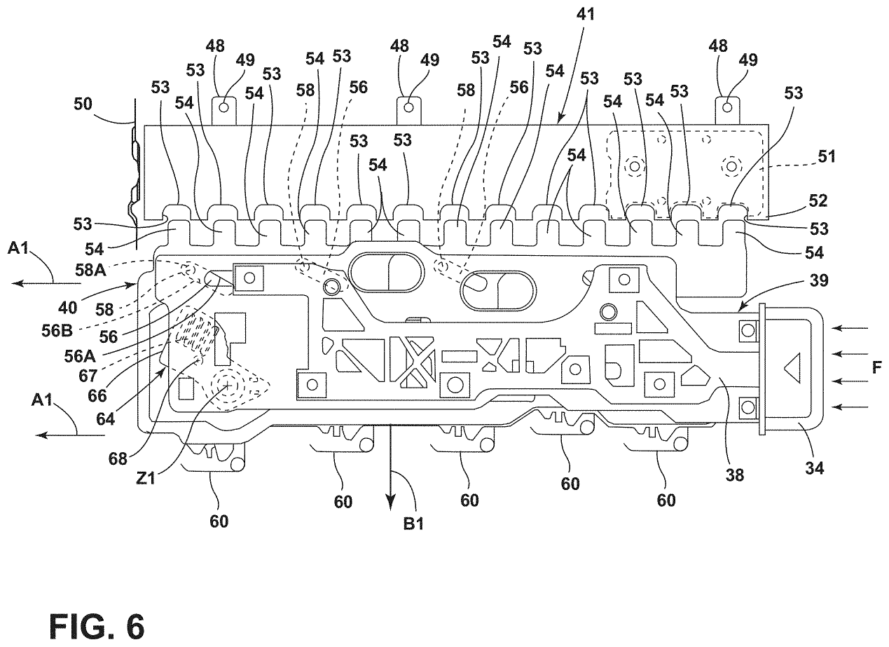

With further reference to FIGS. 5-7, reinforcement bracket 41 may include a plurality of mounting structures such as tabs 48 having openings 49 that receive threaded fasteners or the like to rigidly secure the reinforcement bracket 41 to the lower housing member 30B (FIG. 4). A stop bracket 50 and fixed locking bracket 51 also prevent movement of reinforcement bracket 41. A side 52 of reinforcement bracket 41 includes a plurality of recesses 53 that receive projections 54 of locking bracket 40 when the locking bracket 40 is in a locked or engaged position (FIG. 5). When the locking bracket 40 is in a release position (FIG. 6), the projections 54 of locking bracket 40 are positioned outside of the recesses 53 of reinforcement bracket 41 to thereby permit movement of the locking bracket 40 in a fore-aft direction (arrow A1) to thereby permit fore-aft movement of top 28.

The actuator bracket 39 includes a plurality of downwardly-extending cam projections 58 that are movably received in elongated angled slots 56 of locking bracket 40. Cam projections 58 may comprise pins or sleeves having cylindrical outer surfaces 58A that slidably engage linear edges 56A and/or 56B of elongated slots 56. Elongated slots 56 of locking bracket 40 are preferably substantially linear. However, slots 56 could be non-linear, and edges 56A and/or 56B of slots 56 could be curved. Elongated slots 56 extend at an acute angle θ defined between the lines “L1” and “L2” (FIG. 5). Line L2 may be parallel to the X axis (FIG. 1). The angle θ may be, for example about 25°, in a range of about 20°-30°, or any other suitable angle, including angles that are less than 20° and angles that are greater than 30°. Similarly, a transverse line “L3” is parallel to the vehicle Y axis. If a user applies a force “F” to the release button 34, the force causes the projections or cams 58 to move along the angled slots 56, thereby shifting the locking bracket 40 in the direction of the arrow B1 from the engaged or locked position (FIG. 5) to the disengaged or unlocked position (FIG. 5).

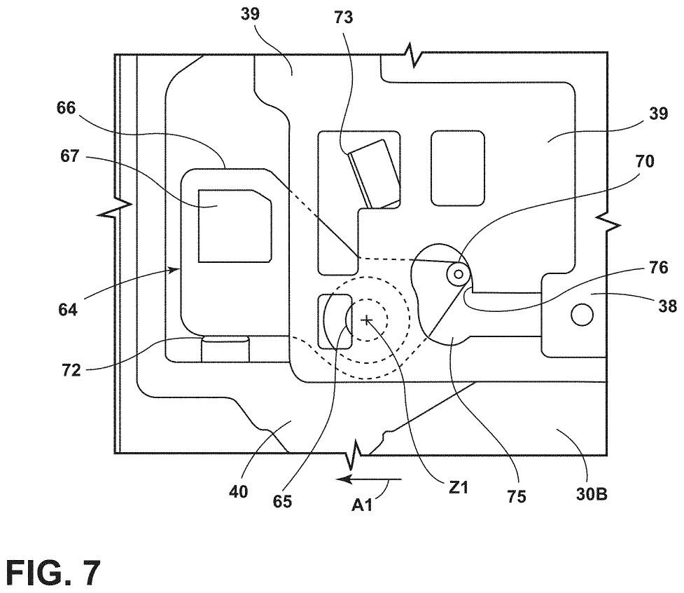

A plurality of springs 60 (FIGS. 5 and 7) bias the actuator bracket 39 in a direction opposite the force “F.” In the illustrated example, springs 60 comprise torsion springs acting on a surface 61 of housing part 30A or 30B, and a transverse surface 62 of actuator bracket 39. The surface 62 of actuator bracket 39 is parallel to the transverse line “L3” (FIG. 5), such that leg 60A of springs 60 slide along transverse surface 62 of actuator bracket 39 as the actuator bracket 39 shifts along in a transverse direction along the line L3. It will be understood that various springs may be utilized to bias the actuator bracket 39. If a user releases the force F (FIGS. 5 and 7), the bias of springs 60 causes the actuator bracket 39 to shift in a direction opposite the arrow A1. The engagement of cams or projections 58 in the angle slots 56 causes the actuator bracket 39 to shift from the unlocked or disengaged position (FIG. 5) back to the engaged or locked position (FIG. 5).

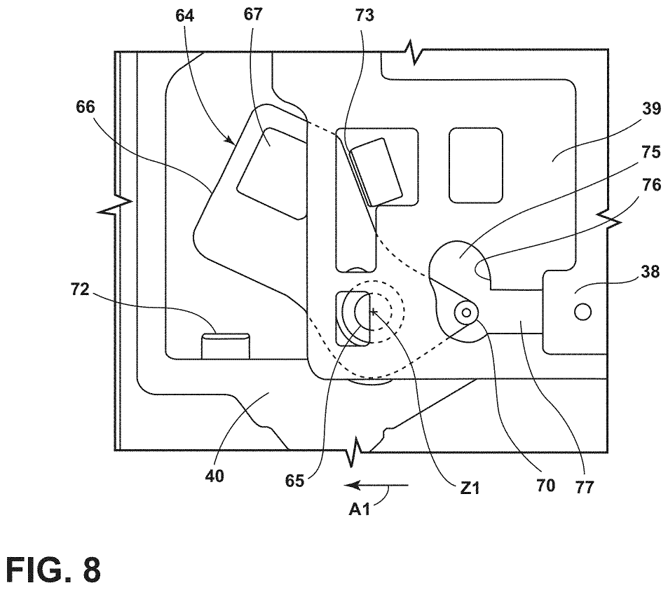

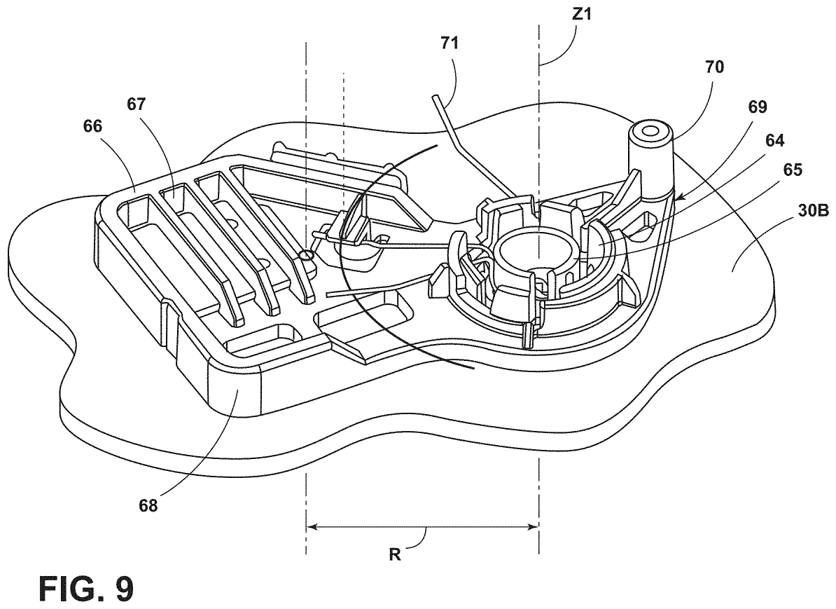

Referring again to FIGS. 5 and 6, an inertia lock member 64 is rotatably mounted to a pivot structure 65 of lower housing member 30B for rotation about a vertical axis “Z1” (see also FIG. 9). Inertia lock member 64 includes a first arm 66 that may include weights 67. The weights 67 result in a center of gravity 68 that is offset from the vertical axis Z1 by a distance “R” (FIG. 9). The inertia lock member 64 also includes a second arm 69 having an upwardly-protruding boss 70. The inertia lock member 64 pivots about the pivot structure 65 from a first position in which arm 66 engages a first stop 72 (FIG. 7) and a second position in which arm 66 engages a second stop 73 (FIG. 8). A torsion spring 71 (FIG. 9) rotatably biases the inertia lock member 64 in a clockwise direction to the release position of FIG. 8. Boss 70 of inertia lock member 74 is received in an opening 75 of actuator bracket 39. When the inertia lock member 64 is in the locked position of FIG. 7, boss 70 engages a surface 76 of opening 75. This contact prevents movement of actuator bracket 39 in the direction of the arrow A1 (FIG. 7). However, when the inertia lock member 64 is in the released or unlocked position of FIG. 8, the boss 70 of inertia lock member 64 is aligned with a slot or open portion 77 of opening 75 in actuator bracket 39 such that actuator bracket 39 can move in the direction of the arrow A1. More specifically, as actuator bracket 39 moves in the direction of the arrow A1 (FIG. 8), the boss 70 of inertia lock member 64 is positioned in the slot portion 77 of opening 75 in actuator bracket 39.

As noted above, torsion spring 71 rotatably biases the inertia lock member 64 into the released position of FIG. 8. Thus, a user can apply force F (FIG. 6) to the release button 34 to release the top or door 28 (FIG. 3) to permit fore-aft movement of top 28 in the direction of the arrow A as required. Upon release of the force on the release button 34, the fore-aft movement is locked due to engagement of projections 54 in recesses 53 (FIG. 5).

If vehicle 1 accelerates in a forward direction, the inertial force acting on inertia lock member 64 causes the lock member 64 to rotate from the unlocked position of FIG. 8 to the locked position of FIG. 7, thereby preventing fore-aft movement or adjustment of the top 28. Similarly, if the vehicle 1 accelerates transversely (i.e. along the Y axis), the transverse acceleration causes inertia lock member 64 to rotate from the unlocked position (FIG. 8) to the locked position (FIG. 7), thereby preventing movement of actuator bracket 39, and also preventing fore-aft movement of top 28. As noted above, torsion spring 71 biases inertia lock member 64 to the unlocked position (FIG. 8). Thus, when vehicle 1 stops accelerating and the inertia force is no longer acting on inertia lock member 64, the inertia lock member 64 rotates from the locked position (FIG. 7) to the unlocked position (FIG. 8).

The mass or weights 67 can be adjusted, and the offset of the center of gravity R (FIG. 9) can also be adjusted to thereby provide for rotation of inertia lock member 64 from the unlocked position of FIG. 8 to the locked position of FIG. 7 at specific predefined forward acceleration of vehicle 1 and predefined transverse acceleration of vehicle 1. For example, inertia lock member 64 may be configured to rotate to the locked position if the vehicle 1 (and inertia lock member 64) accelerates in a forward direction (−X direction) of at least about 30 g and if the vehicle accelerates in a transverse direction (+Y or −Y direction) of at least about 10 g. It will be understood that vehicle 1 may accelerate in a forward direction due to a rear impact on vehicle 1, and vehicle 1 may accelerate in a side-to-side transverse direction due to a side impact on vehicle 1.

It is to be understood that variations and modifications can be made on the aforementioned structure without departing from the concepts of the present invention, and further it is to be understood that such concepts are intended to be covered by the following claims unless these claims by their language expressly state otherwise.

1. A vehicle interior compartment for vehicles having a horizontal fore-aft first direction, and a second direction that is transverse to the first direction, the vehicle interior compartment comprising:
a base structure configured to be fixed to a vehicle body structure;
an interior storage compartment mounted to the base structure, the interior storage compartment having a storage space and an upper opening providing access to the storage space;
a movable door that is configured to move horizontally from an open position permitting access to the storage space to a closed position closing off the upper opening;
a latch mechanism configured to retain the movable door in the closed position when the latch mechanism is latched, and wherein the latch mechanism permits the movable door to move to the open when the latch mechanism is unlatched;
a movable latch release operably connected to the latch mechanism whereby a user can move the latch release from a rest position to released position to unlatch the latch mechanism;
a bidirectional inertia lock having an unlocked configuration in which the movable latch release can be moved to unlatch the latch mechanism, the bidirectional inertia lock having a locked configuration in which the latch mechanism cannot be unlatched to open the movable door, the bidirectional inertia lock including an actuator member and an inertia lock member;
wherein the actuator member is movable from a rest position to an actuated position, and wherein movement of the actuator member from the rest position to the actuated position unlatches the latch mechanism;
and wherein the inertia lock member is rotatable about a vertical axis from an unlocked position to a locked position, and wherein the inertia lock member permits movement of the actuator member to the actuated position when the inertia lock member is in the unlocked position, and wherein the inertia lock member prevents movement of the actuator member to the actuated position when the inertia lock member is in the locked position, the inertia lock member having a center of mass that is offset from the vertical axis such that the inertia lock member 1) rotates to the locked position in response to acceleration in the first direction; and 2) rotates to the locked position in response to acceleration in the second direction.

2. The vehicle interior compartment of claim 1, wherein:
the interior storage compartment includes first linear guides;
the door slidably engages the first linear guides to permit linear fore-aft movement of the door relative to the interior storage compartment when the latch mechanism is released.

3. The vehicle interior compartment of claim 1, wherein:
the latch mechanism includes a base member fixed to the base structure and a locking member that selectively engages the base member when the inertia lock member is latched to prevent movement of the door.

4. The vehicle interior compartment of claim 3, wherein:
the base member comprises an elongated base structure extending in a fore-aft direction and including a plurality of recesses;
the locking member includes at least one protrusion that engages at least a selected one of the recesses when the inertia lock member is latched to prevent fore-aft movement of the door;
and wherein movement of the latch release from the rest position to the released position disengages the protrusion from the at least one recess to permit fore-aft movement of the door.

5. The vehicle interior compartment of claim 4, wherein:
the latch release and the locking member are movably interconnected by at least one cam member and cam surface whereby movement of the latch release in the first direction causes the locking member to shift in a direction that is transverse to the first direction.

6. The vehicle interior compartment of claim 5, wherein:
the locking member includes a plurality of elongated slots that extend at an acute angle relative to the first direction;
the latch release comprises an actuator bracket having protrusions that are received in the elongated slots.

7. The vehicle interior compartment of claim 6, including:
at least one spring biasing the actuator bracket to the rest position whereby the at least one spring causes the actuator bracket to shift to the rest position after a user releases the latch release to thereby shift the at least one protrusion of the locking member into engagement with a recess of the base member.

8. The vehicle interior compartment of claim 4, wherein:
the inertia lock member includes a lock surface that engages the latch release and prevents movement of the latch release to the released position when the inertia lock member is in the locked position.

9. The vehicle interior compartment of claim 8, including:
a spring biasing the inertia lock member to the unlocked position.

10. The vehicle interior compartment of claim 9, wherein:
the latch release includes an opening;
the lock surface of the inertia lock member comprises a protrusion that is received in the opening.

11. The vehicle interior compartment of claim 10, wherein:
the opening in the latch release includes an edge portion forming a stop that engages the protrusion and prevents movement of the latch release to the released position when the inertia lock member is in the locked position, and wherein the opening in the latch release includes a portion that receives the protrusion and permits movement of the latch release to the released position when the inertia lock member is in the unlocked position.

12. A vehicle having a fore-aft first direction and a side-to-side second direction that is transverse to the first direction, the vehicle comprising:
a base structure;
an interior component that is movably mounted to the base structure for horizontal fore-aft movement between first and second positions;
a latch mechanism having latched and unlatched configurations, wherein the latch mechanism prevents fore-aft movement of the interior component when the latch mechanism is in the latched configuration, and permits fore-aft movement of the interior component when the latch mechanism is in the latched configuration;
a manually movable latch release operably connected to the latch mechanism whereby manual movement of the latch release from a rest position to a released position unlatches the latch mechanism;
an inertia lock member that is rotatable about a vertical axis, the inertia lock member having a center of mass that is offset from the vertical axis such that the inertia lock member rotates from an unlocked position to a locked position in response to acceleration in the first direction and in response to acceleration in the second direction, and wherein the inertia lock member prevents movement of the latch release to the released position when the inertia lock member is in the locked position.

13. The vehicle of claim 12, wherein:
the inertia lock member rotates from an unlocked position to a locked position in response to acceleration in the first direction only if the acceleration in the first direction is equal to or greater than about 30 g.

14. The vehicle of claim 12, wherein:
the inertia lock member rotates from an unlocked position to a locked position in response to acceleration in the second direction only if the acceleration in the second direction is equal to or greater than about 10 g.

15. The vehicle of claim 12, wherein:
the vehicle comprises a body structure;
the latch mechanism includes a reinforcement bracket fixed to the body structure, the reinforcement bracket including a plurality of recesses, the latch mechanism further including a locking member that moves fore-aft with the interior component and selectively engages at least one of the recesses of the reinforcement bracket to retain the interior component at a selected fore-aft position.

16. The vehicle of claim 15, wherein:
the latch release is movably mounted to the interior component for fore-aft movement relative to the interior component between the rest and released positions, and wherein the latch release and the locking member are operably interconnected by cam surfaces such that fore-aft movement of the latch release shifts the locking member in a direction that is transverse to the fore-aft direction.

17. The vehicle of claim 16, wherein:
the inertia lock member engages a stop surface of the latch release when the inertia lock member is in the locked position to prevent movement of the latch release to the released position.

18. The vehicle of claim 12, wherein:
the base structure comprises a storage compartment having an upwardly-facing opening;
the interior component comprises a door that closes off the upwardly-facing opening when the door is in the first position, and permits access to the upwardly-facing opening when the door is in the second position.

19. The vehicle of claim 18, wherein:
the first direction is a vehicle forward direction;
the door moves in the vehicle forward direction from the first position to the second position.

20. A method of preventing movement of a vehicle interior component of a vehicle when the vehicle experiences acceleration in a forward direction exceeding a predefined first acceleration and when the vehicle experiences acceleration in a side-to-side direction exceeding a predefined second acceleration, the method comprising:
providing an inertia lock member that is rotatably connected to a vehicle component for rotation about a vertical axis;
movably connecting an interior component to the vehicle in an interior of the vehicle;
configuring the inertia lock member to rotate from an unlocked position to a locked position to prevent movement of the interior component when the vehicle experiences acceleration in a forward direction exceeding a predefined first acceleration and when the vehicle experiences acceleration in a side-to-side direction exceeding a predefined second acceleration.
